(19) United States
(12) Patent Application Publication
(10) Pub. No.: US 2011/0054929 A1
(43) Pub. Date: Mar. 3, 2011

(54) Stem Cell Marketplace

(75) Inventor: Christopher J. Centeno, Broomfield, CO (US)

(73) Assignee: CELL SOLUTIONS COLORADO LLC, Broomfield, CO (US)

(21) Appl. No.: 12/873,530

(22) Filed: Sep. 1, 2010

Related U.S. Application Data
(60) Provisional application No. 61/238,764, filed on Sep. 1, 2009.

(51) Int. Cl. G06Q 50/00; G06Q 30/00

(52) U.S. Cl. 705/2

(57) ABSTRACT

Computerized methods and systems for a stem cell marketplace are disclosed herein. Aspects of the stem cell marketplace include a registry that includes information and data necessary for a user to optimize a particular stem cell need. Aspects provide uniformity and certainty on how to proceed in personalizing a particular stem cell need, including autologous stem cell needs.

### FIELD OF THE INVENTION

The invention generally relates to a stem cell marketplace and methods and systems for using the same. More specifically, the invention relates to a registry for storing types of stem cells and procedures required for their procurement, including manipulation of the cells or procedures for a target use. Typical registries also store relevant stem cell literature, intellectual property topics, medical topics, and other like interests or concerns. Computerized systems and methods are also provided for implementation of the marketplace.

### BACKGROUND OF THE INVENTION

Stem cells are characterized for their capacity to renew and, in some cases, differentiate into a diverse number of more-specialized cell types. Stem cells are present in most, and likely all, multi-cellular organisms, providing the organism the ability to repair damaged tissue, and the ability to replenish and/or maintain specialized cells in various tissues of the organism.

Over the last several decades use of stem cells has become a focus for research and development, especially in cell biology, immunology, tissue engineering, transplantation biology, and regenerative medicine. In all cases, the potential for cell-based therapeutic application has provided a new platform for advancement in human and veterinarian based medicine.

Although great strides have been made in stem cell-based therapeutics, a number of issues hinder advancement toward wide-spread use of the technology. Perhaps the most problematic of these issues is cell sourcing of the stem cells to be used in any one therapeutic application. Human and veterinarian therapeutic use requires that cells be in large quantity and maintain uniformity of activity. Further, cells must be pathogen free and implant in the patient with a minimum of immunogenic/rejection based problems. Given the large variety of stem cell options it is difficult for those in the field and those who wish to benefit from the field to optimize options for their particular needs.

An important aspect of cell sourcing is the choice between use of autologous and non-autologous stem cells and the tissue source from which those cells have originated. Stem cells are cells typically produced and provided by companies for targeted uses, for example, Haerfield Heart Science Centre, targeting particular stem cells to produce replacement valves for use in the heart, and/or cord blood or fetal cells obtained for use in a targeted patient, for example, a company that obtains cord blood for potential use in a child in need thereof in later life. These cells are typically sold or obtained in significant numbers, having been tested for pathogens and treated in a manner to maintain uniformity. However, stem cells generally must overcome natural host immunologic rejection processes, which generally prevent wide-spread therapeutic success, especially in human targeted use.

More recently, investigation and development into autologous adult stem cell-based procedures has gained momentum in the therapeutic world. Importantly, autologous stem cell-based therapeutics overcome the host immunologic rejection process and eliminates concern over pathogen contamination. However, autologous stem cell procedures require obtaining stem cells from a patient source, expanding the cells in vitro in large quantities (usually over several weeks), and reintroducing the cells at a target site under conditions that optimize the use. These procedures have shown some success, but also significant inconsistency due to the variation in the various procedures used to harvest, manipulate and deliver the stem cells. Each of these steps provides potential aspects of non-uniformity for use of the stem cells in any one therapeutic application. For example, stem cell source site, in vitro culture conditions (including growth factors, base medium, oxygen levels, temperature, and type of culture container), exact site and presence of implant matrix, and/or other implant material, can each lead to a different clinical outcome. There is presently little uniformity and exchange of information for these autologous adult stem cell-based procedures except at scientific meetings or in journal articles, leaving a health care professional (and patients) significant concerns over the outcome of any one procedure when using autologous stem cell therapeutics. In addition, patients need to have expanded opportunities to utilize stem cell technology in a knowledgeable environment, often optimized for their use.

Against this backdrop the present invention has been developed.

### SUMMARY OF THE INVENTION

The present invention provides methods and systems for assessing information (and data) for the practice of a stem cell therapy in a target health care industry. This stem cell specific information and data are stored in a stem cell registry by members who belong to the registry service. Members of the stem cell registry input information and data, i.e., items, to the registry that facilitate understanding and advancement in the field of stem cell therapeutics, as well as to sell their product and services to stem cell registry users. Methods and systems described herein provide a surprising advantage to both members and users, for example, to the effectiveness of any one stem cell therapeutic and provide a platform for consistency and/or uniformity of care not present in the stem cell field to date.

Aspects of the invention allow users, i.e., patients, physicians, and other health care professions, to open and manage (or communicate with) stem cell members, where uniformity of patient care and knowledge of potential health and business benefits and risks (including relevant intellectual property on a cell source, cell use, process for identification, process for isolation, and the like) are available. Registry members and users are thereby brought together to provide a significantly more uniform and optimal dissemination of potential therapeutics and thereby provide personalized and optimized health care in the stem cell field. The stem cell registry, registry members, and registry users combine to form a stem cell marketplace, dedicated to enhancing the results and consistency/uniformity of stem cell based therapeutics.

In one embodiment herein, a stem cell marketplace is provided to match potential users with potential stem cell members, i.e., licensors or owners of marketplace information or data. The marketplace maximizes the users' “need” parameters, whether those parameters include cost, expectancy of results, and level of acceptable complication risk, intellectual property concerns, and the like. The results of the match provide optimized parameters for the user to best service his or her stem cell therapeutic need(s). In other embodiments, the results of the match are combined with other users of the registry to identify potential need(s) for a group of similarly situated users and to provide a competitive advantage to particularly deserving user groups, i.e., a group of children having type I diabetes. In additional embodiments, members can be matched to package therapeutics for a user, where a group of members may provide all the information, intellectual property and know-how to perform any one stem cell based procedure, i.e., a first member provides the rights to practice a particular harvest and delivery procedure for target stem cells and another member provides a novel factor required for proper differentiation of those cells.

The stem cell marketplace provides unexpected and surprising benefits for decreasing the time required for a user to identify a stem cell need, for decreasing the cost necessary for a user to identify a stem cell need, for optimizing or personalizing a users' access to stem cell information, data and potential therapeutic potentials, for enhancing negotiations between potential users and members, for providing members with a platform for disseminating their stem cell based options, and for providing a platform for advancing and promptly updating stem cell research in general.

In aspects of the invention the stem cell marketplace allows marketplace members to input and store information and data relevant to a potential health care user's needs onto a registry. Marketplace members input and store information and data relevant to stem cell tissue source parameters, procedures required to obtain the stem cell (whether autologous or non-autologous), cost parameters, re-implant parameters and laboratory parameters. Upon agreement between the marketplace member and user, all information required to perform a procedure or purchase a stem cell line or associated material is provided and/or performed. So for example, where a member is providing a procedure for autologous stem cell harvest, manipulation and implantation back into the patient (the user in this case), a patient would receive the information required to perform each of these aspects, including any licenses or waivers necessary to practice the member's intellectual property (IP). In some cases, the member would agree to perform the requested procedure at the member's facilities, at which point the user would simply select the best fit results from the registry and hire the member to perform the selected procedure. Members would strive to update the registry and compete with other members for particular users' business, although certain parameter requests would be objective in nature, other parameters would allow the member to provide subjective information (to some extent allow the member to advertise their procedure or product).

In some cases the results require that a stem cell marketplace member be a provider of the cells, in other cases the member be an autologous stem cell procurement and use information provider, and in some cases a member be an owner of intellectual property relevant to compositions and procurement methods useful in the field of stem cell therapeutics. Other cases would include members that provide non-autologous and autologous stem cells or services for locating and/or storing cells for future use, i.e., cord blood, embryonic stem cells, or placenta storage after childbirth. Each of these member generated units of information or data is termed an item. Each item inputted is useful for either facilitating users' needs or for advancing or illuminating an issue within the stem cell art.

In other aspects, the stem cell marketplace allows a marketplace user to input a tissue source of need, procedural parameters, cost parameters, re-implant parameters and/or laboratory parameter(s). Software will then provide a series of follow-up queries to ensure that the proper or most appropriate considerations be considered and optimal results provided to the provider/user. Once identified by the user, negotiations and/or purchase of the requested information/procedure are performed. The registry can include differentiation between members that provide information only or members that can provide information or facilities to practice a stem cell therapeutic, i.e., a member may wish to convince a user to perform a procedure at the member's facility or may require that the user have a health care profession that will use the member's information to accomplish the stem cell therapeutics. The registry may also include differentiation between members based on a for-profit or not-for-profit basis.

Aspects of the invention are performed on computerized systems for implementing the stem cell marketplace. Computerized systems can include hardware elements (with functional elements), a registry for storing at least two member generated stem cell items, a software element, and the like. In some embodiments the computerized system includes a network interface, e.g., internet interface, for disseminating the marketplace information and data to multiple users and members.

These and various other features as well as advantages which characterize the invention will be apparent from a reading of the following detailed description and a review of the appended claims.

### BRIEF DESCRIPTION OF THE FIGURES

FIG. 1 illustrates a flow chart of one embodiment in accordance with the present invention.

FIG. 2 illustrates a schematic of one potential computerized system in accordance with embodiments of the present invention.

FIG. 3 illustrates a flow chart in accordance with one embodiment of the present invention. The figure provides one stem cell marketplace filter embodiment.

FIG. 4 illustrates a marketplace search and entry in accordance with one embodiment of the invention.

FIG. 5 illustrates a schematic of a computerized system having a network interface.

### DETAILED DESCRIPTION OF THE INVENTION

The following definitions are provided to facilitate understanding of certain terms used frequently herein and are not meant to limit the scope of the present disclosure.

“Stem cell(s)” herein refers to any cell or source of cells that retains the capacity to renew through mitotic cell division and differentiate into a diverse range of specialized cell types. In some cases, stem cells are from an autologous cell source, stem cell sources can include bone marrow, adipose derived stem cells, endothelial stem cells, and the like. Types of stem cells include: placental derived stem cells, embryonic stem cells, fetal stem cells and adult stem cells, e.g., mesenchymal stem cells (MSCs), endothelial stem cells, neural stem cells, haematopoietic stem cells, and the like.

“Stem cell marketplace item” or “item” is any relevant information, data, procedure, etc that a member inputs and stores onto the Registry for the purpose of facilitating a users' stem cell needs or enhancing the knowledge and understanding within the stem cell art.

“Stem cell marketplace member” or “marketplace member” is any person or entity that provides an approved source of information, services and/or materials for use in the registry of the stem cell marketplace. In some cases the marketplace member is referred to as a “member.”

“Stem cell marketplace user” or “marketplace user” refers to a physician, veterinarian, nurse, caregiver, or patient in need of Stem Cell Marketplace registry methods and systems. A marketplace user may also refer to a users' agent. In some cases the marketplace user is also referred to as a “user.”

“Stem cell marketplace user need” or “need” refers to any potential benefit that a user may require in the stem cell art and that can be provided by a stem cell marketplace member. Needs can include information or data toward purchase of a specific non-autologous stem cell line, procedural information for harvest, manipulation and re-implantation of autologous stem cells, intellectual property concerns, costs, and the like.

“Patient(s)” is any person or animal in need of a stem cell based therapeutic, for example a person (or non-human in veterinarian medicine) in need of knee cartilage repair that requires the information and/or services provided in accordance with embodiments of the present invention. A patient can be a marketplace user.

“For profit” or “for non-profit” refers to the status of a stem cell marketplace user, the identifier is provided to coordinating potential license terms and maximizing the search for each particular group. For instance, a non-profit user may be entitled to more favorable licensing conditions.

“Autonomous” herein refers to a situation where both recipient and donor is the same person or animal, for example, stem cells are harvested from a patient for use as a therapeutic in that same patient.

“Registry” herein is the data base of information and data contained in the Stem Cell Marketplace.

“Intellectual property” or “IP” refers to proprietary information as protected by U.S. or foreign patent rights, trademark rights, copyright rights or the like. IP can include a licensors' know-how, trade secrets, proprietary information and the like. IP is often the subject of licensing agreements between stem cell marketplace members and users.

“Control program” refers to software or other like material that manages the traffic between terminals and a central computer.

“Computing device” refers to a PC or other like device having a processing unit, system memory, system bus, disc drive(s), interface, storage, and other like features.

“Information” refers to a broad category of procedures, systems, devices, intellectual property, know-how, data and the like useful to the user.

“Optimization” of user's criteria for identifying procedures or materials via the stem cell registry is typically based on providing uniform and consistent results or options to that user. In some cases an optimal result may be personal to that user due to subjective parameters that are weighed more critically than another user's parameters.

### MODES FOR CARRYING OUT EMBODIMENTS OF THE INVENTION

Embodiments of the invention include stem cell marketplace systems and methods for providing a stem cell user and a stem cell member with optimal information and/or services for a successful stem cell based procedure or purchase. In some instances the systems and methods provide a platform for facilitating exchange and availability of information related to stem cells in an accessible format. The systems and methods of the invention provide an unexpected utility to optimizing stem cell use over the non-uniform dissemination of information, as well as therapeutic use, currently in the art.

Furthermore, embodiments of the invention implement the systems and methods herein in hardware, firmware, or a combination of both hardware and software. These alternative embodiments are, therefore, implemented as computerized systems. Computerized systems can include a network interface, e.g., internet interface.

In one embodiment, stem cell marketplace members store “items” to a registry herein by inputting one or more relevant item parameters important to stem cell implant procedures, stem cell purchases, stem cell understanding, and the like. Item parameters can include purchase information for specific stem cell lines, procedural information, for part or all of, harvest, manipulation and re-implantation of autologous stem cell lines, supplemental materials for use in stem cell implants and secondary considerations that impact a potential users interest in a stem cell line or procurement procedure, i.e., intellectual property rights, scientific journal articles, feed-back from previous users of a particular cell line or procedure, subjective information provided by a member, licensing terms, and the like. Members can be charged a fee for belonging to the marketplace. Member fees can be modified based on for-profit or not-for-profit distinction. In some cases, members can be charged on the basis of profit obtained through contacts made via the stem cell marketplace, e.g., a 1% royalty.

Stem cell marketplace users are individuals or entities that wish to obtain stem cell items from the registry to optimize the users' needs. Users can include hospitals, clinics, research institutions, consultants, individual patients and agents for individual patients. In some aspects the options provided herein are a consistent and uniform approach to performing stem cell repair procedures throughout the user base. In addition, aspects include options that minimize cost, maximize clinical results, minimize intellectual property issues, e.g., patent infringement, and provide a dynamic risk assessment for the user of any one searched procedure. Aspects also provide incentive to members and users to optimize/personalize their stem cell therapeutic needs.

Methods and systems are provided for implementing stem cell marketplace embodiments in accordance with the present invention. Methods include the process of providing and obtaining information and data useful to a marketplace user, accessing that information or service, and identifying the best options for that particular user. Systems include the registry, hardware elements, software and services required to implement aspects of the present invention. Systems can also include a network interface.

As noted previously, the stem cell marketplace provides unexpected and surprising benefits for decreasing the time required for a user to identify a stem cell need, for decreasing the cost necessary for a user to identify a stem cell need, for optimizing or personalizing a users' access to stem cell information, data and potential therapeutic potentials, for enhancing negotiations between potential users and members, for providing members with a platform for disseminating their stem cell based options, and for providing a platform for advancing and promptly updating stem cell research in general.

It is also noted that the stem cell marketplace can be used by members to access other member's items, unless a member specifies that the item is not for public examination. Where items are open for other members to review, the information can be used to spur technologic advance within the stem cell field; where an item is not for public review and only for confidential review by a user, the member can feel secure that the item is maintained in confidentiality.

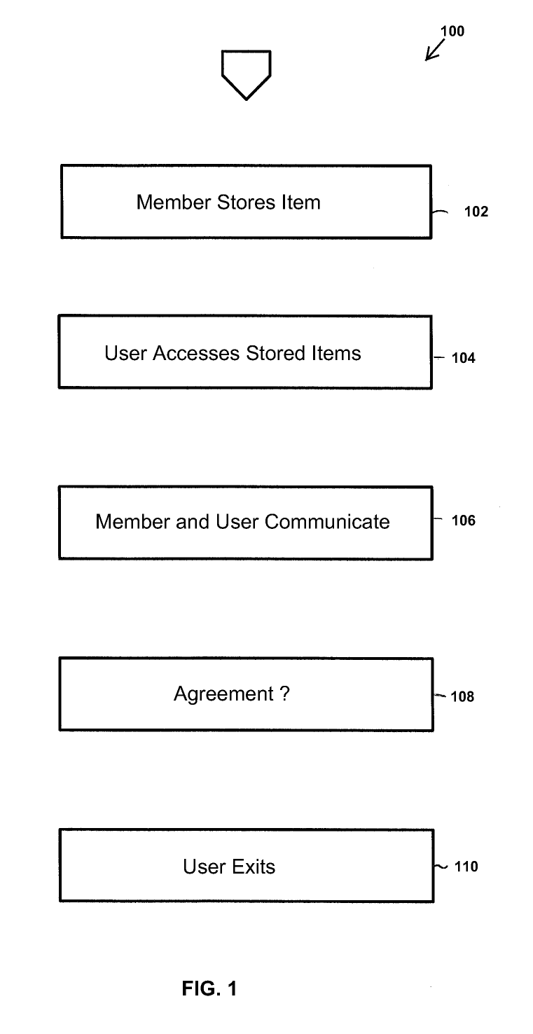

FIG. 1 illustrates a computerized method embodiment 100 of the invention comprising: one or more members of the marketplace entering and storing stem cell items to a registry database 102 (the number of members and items stored to the registry is limited only by the capacity of the registry and is envisioned to be sufficient for several hundred to several thousand members, also noting that any one member may store multiple items); one or more users of the marketplace use software to access and identify needs provided by the one or more members 104; a user and member communicate based on identification of the user need with the members' item 106; the user and member come to an agreement on whether the member should provide the item or items to the user 108; and the user exits the registry or performs another need based access of the registry 110.

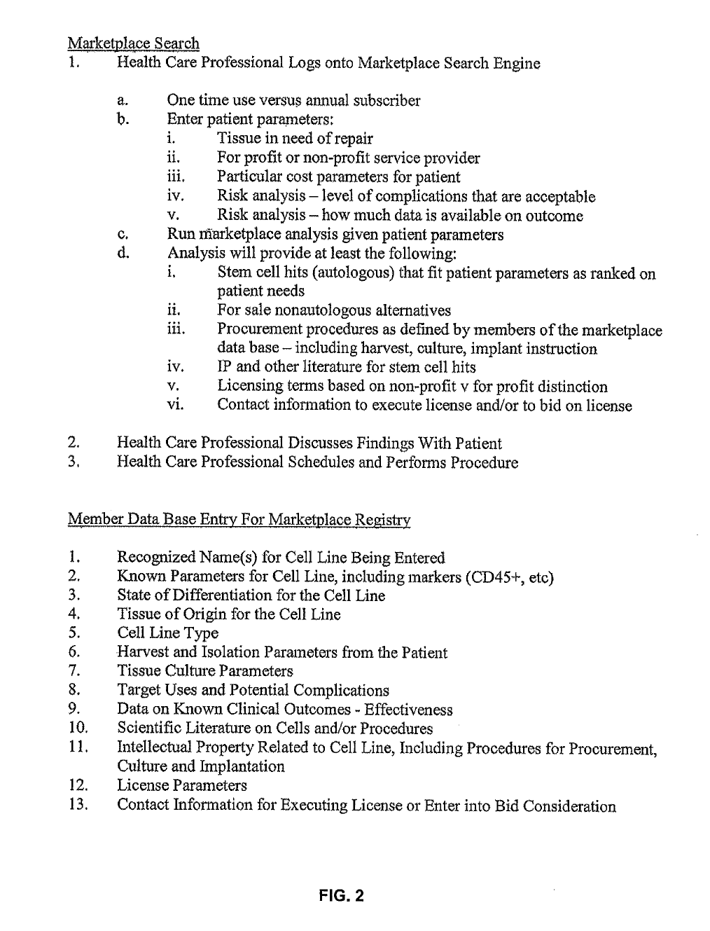

Referring to FIG. 2, a series of software driven search engine queries for a user, described as a health care professional, are shown, as well as a series of potential member items that can be entered and stored into the registry. Each series of options allows for an optimization or personalization of results from the stem cell marketplace. These software driven queries relate to boxes 102, 104 and 106 of FIG. 1. In this particular example, the health care professional is analyzing member items for a patient in order to optimize or maximize the patients personalized treatment and thereby enhance the uniformity of the patient's therapy.

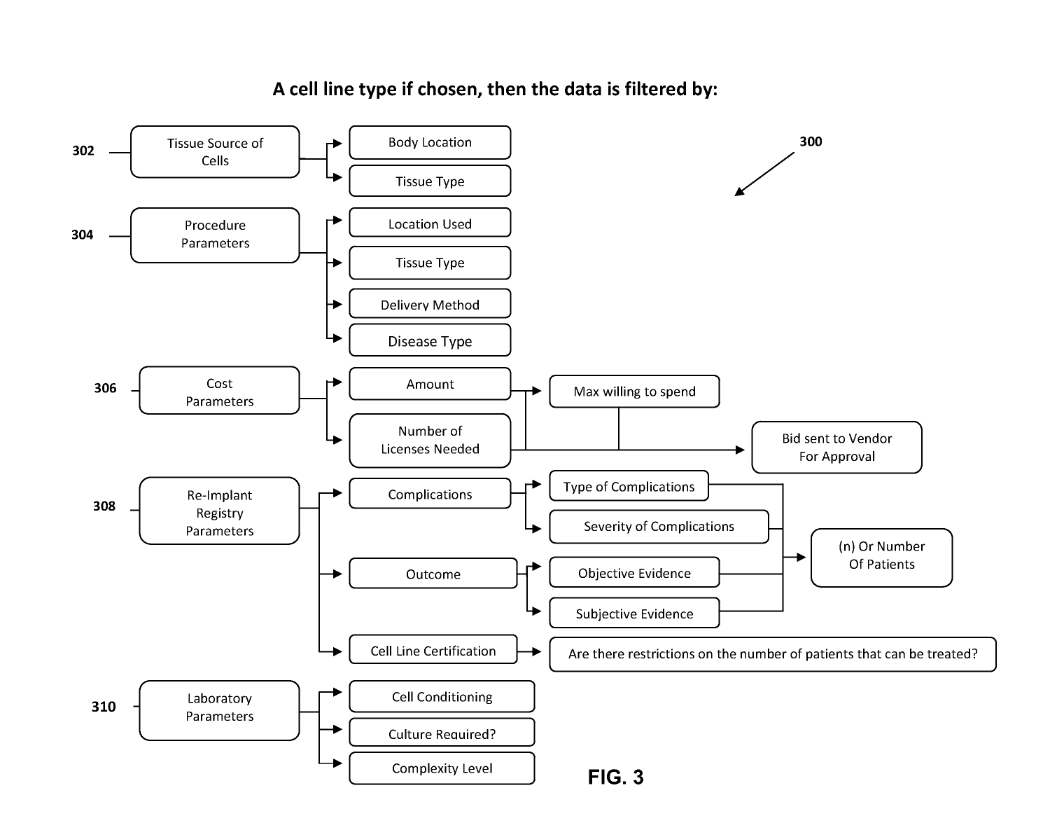

FIG. 3 illustrates an embodiment of the invention for a user to filter via software through an illustrative members' input information or items. The user enters the registry through a predetermined access point, for example, by pre-registering with the web-site. In some aspects registration may require an annual payment or a one-time fee. It is envisioned where the user is a patient entering the site; it may be a one-time fee for using the registry, whereas an institutional user may purchase an annual registration and have year-round access.

Once entered onto the registry, the user is provided with, for example, a control program (or other like programs/software), and data showing the interactive options available to the user. In one embodiment, the user can simply request all, for example, results for a particular repair request. For example, request all information and data relevant to stem cell repair therapeutics for type 1 diabetes. In another embodiment, the results could further be limited by various parameter limitations, for example the user provides information on whether target use requires autologous or non-autologous cells. For example, a user may request an autologous based repair procedure option for cartilage repair on his or her knee.

In some cases, a control program would access the registry and then run through a series of options based on entered filter parameters the user requested to provide a more personalized registry selection or result. In some embodiments, the software is requested to access the registry and provide results for a particular target repair after a series of filtering parameters are entered. These parameters help focus or direct the user toward identifying a personalized result, for example, a user may request a repair based on minimizing complications and cost while showing less priority toward success rate. As discussed further below, the methods and systems herein allow the user to personalize a stem cell repair procedure or purchase, and in so doing, find options and uniformity not available prior to the present disclosure.

Addressing FIG. 3 again, in some embodiments, a control program accesses the registry, and information and data is downloaded to the user's hardware elements, e.g., computing device 300. Aspects of the invention can include a download of at least the following options: 1) an option to allow a user to identify a tissue source of stem cell required for a particular stem cell implant 302; 2) a procedural parameter identification, this provides the user information regarding procedures that can be used to accomplish option input (1) 304; 3) a cost parameter identification, this option provides the user information regarding cost and licensing terms available for the various options identified in the registry 306; 4) a re-implant registry parameter identification, this option provides outcome feedback to the user, including information directed toward complications risk 308; and 5) a laboratory registry parameter, this option provides input as to where particular options are available and a listing of potential laboratory characteristics required to perform identified options 310.

With regard to tissue source identification, tissue source identification can include at least: a location in the body for the source of the stem cells. Possible tissue sources include: adipose tissue, bone marrow, peripheral blood, fetal tissue, and cord blood. Where the source is non-autologous, identification can include the species at issue, for example, bone marrow for an equine or specified cell surface marker.

A registry member would include and store their particular cell line or procedure tissue source, including the body location and the tissue type. This data/information (item) allows the user to identify the cells that will be used within any particular repair procedure. For example, the cells for a particular member may be non autologous mesenchymal stem cells found in adipose tissue versus hemeatopoetic stem cells derived from marrow.

Where a user is unsure of a particular source, options can be provided for each selection or can be adjusted by the software to identify the best source for a procedure based on the user's other input parameters. For example, where a user requires the procedure to result in high likelihood of success, the tissue source results may be reflected to provide sources (and thereby members) that have shown the best outcomes for the request. It is also envisioned that a user may wish to limit the tissue source or type based on personal preference outside of a scientific setting, for example, some users may not want to use adipose derived cells due to the process required to obtain the cells (liposuction). In this case the user would limit the target tissue source regardless of clinical outcome.

With regard to procedural parameters, a member can input and store at least the following onto the Registry: the exact location where the stem cells are harvested from, the tissue type from which the stem cells will be recovered, the delivery method for the harvested stem cells, and any disease(s) that the procedure is believed to treat. For example, illustrative information may include: a procedure that requires that mesenchymal stem cells be harvested from iliac crest bone marrow, that the harvested cells (with or without additional manipulation) be delivered by IV to the patient over the course of 1 to 3 hours and that the procedure be repeated 2 or 3 times within a first week. The procedure is known to be useful for the treatment of type 1 diabetes or other diseases that can be treated using stem cell therapy.

Possible diseases that the procedure parameters for stem cell therapy cover include: leukemia, myelodysplastic syndrome, phagocyte disorder, metabolic disorder, histiocytic disorder, inherited erythrocyte abnormality, inherited immune system disorders, heart disease, types 1 and 2 diabetes, stroke, rheumatoid arthritis, ALS, spinal cord injury, burns, cartilage loss, muscular dystrophy, liver disease, lung disease, Parkinson's disease, Parkinson's syndrome, Alzheimer's disease, tendonitis, ligaments injuries, muscle injuries, tendon tears, fracture non-union, spinal cord injury, stroke, brain injury, hearing disorders, peripheral nerve injury, disorders of vision, and other like ailments.

A user accessing the procedural parameters may again limit the results by software filtering based on selected information options, i.e., all procedures that result in treatment of type 1 diabetes, or by limiting information options, i.e., no procedure that requires bone marrow as the tissue type, or intravenous (IV) as the delivery method.

With regard to cost parameters, a member can input and store to the Registry at least the following: the estimated cost for each procedure or sale at issue, perhaps broken down for target repair sites, the number of potential licenses required to perform a procedure or purchase a stem cell line. A member may potential licensing terms or a procedure for direct negotiations with the member based on any one user's specific needs. So for example, a member may include a itemized break-down of the price for purchasing a procedure for use in particular target sites, e.g., $1,500 for procedure used in repair of cartilage in knee, $1,700 for procedure used in repair of cartilage in shoulder joint, etc.

In some aspects a member may wish to provide exclusive licensing terms to a potential user allowing the user, for example, exclusivity to the member's information/items. Exclusivity could be tied to a geographic area, time frame or use. In some cases this exclusivity could promote the use of the member's information.

A user may access the cost parameters by viewing the cost of the various results provided by members or by filtering results based on the maximum cost the user is willing to pay. In addition, a user may limit the results by indicating the maximum number of licenses the user is willing to execute based on the particular procedure. For example, some procedures may require the user to pay a first member for the harvest and delivery of the particular stem cells and another member for a proprietary growth factor composition required to differentiate the stem cells into the cells required for the repair procedure. A user may also use this set of parameters to provide a bid to a member for review and approval based on the particular users needs. The bid process may include multiple iterations between user and member(s) to obtain an adequate personalized procedure.

With regard to re-implant parameters, a member can input and store at least the following: prospective complications that may arise from use of cell line or procedure, including the types of possible complications and the severity of the possible complications; potential outcome of the stem cell line or procedure including any objective evidence that the member is aware of (imaging evidence, physical examination data, statistical analysis of other like treated patients, journal articles, and expert provided conclusions) as well as subjective evidence that the member is aware of (evidence can include patient testimonials, functional or symptom based questionnaires, self-reported improvement, and member provided comment); and a cell line certification where the member provides evidence that procedure or stem cell line are as indicated by the member (in some aspects the member may limit the availability of particular cell lines or procedures to artificially elevate demand for particular results).

A user may access the re-implant parameters by filtering results based on level of complication that the user views as acceptable, for example, some users may be unwilling to risk serious complication due to a particular cell line or procedure and thereby request an option where health complications are low. In contrast, some users may prefer to filter out all results that fail to provide objective evidence of success, including at least X number of satisfied patient testimonials and accept a slightly higher complication rate in exchange for higher quality efficacy data.

With regard to laboratory parameters, a member will input and store at least the following: materials and equipment required to perform any one procedure or the materials and equipment necessary to store a stem cell line prior to delivery to the patient; the in vitro culturing techniques and materials needed to expand any one particular stem cell of use and the cell conditioning materials required to expand and/or differentiate stem cells. Members may provide details required for a user to store, expand and/or differentiate stem cells of interest or may provide information related to the members capacity to perform the service for an additional price (or include the service as part of the cost parameters previously described).

A user may access the laboratory parameters via software by filtering results based on conditioning parameters, complexity of cell expansion and/or differentiation procedure, and/or availability of laboratory equipment.

Additional item parameters that can be included in a registry embodiment of the present invention include: as part of the tissue source, members would include: 1) all known cell marker parameters used to identify the harvested stem cells or the delivered stem cells (post expansion and differentiation); 2) intellectual property parameters that the member is aware of including both domestic and foreign patent rights, potential adverse intellectual property rights to the members, i.e., possible intervening or blocking rights to the members cell line or procedure, trademark and copyright issues with using the members cell line(s) and/or procedures; 3) suggested cell line and/or procedural combinations of member options, for example, proposed combination of a members procedure for harvesting a stem cell line combined with another members procedure for delivering cells to a target site. The two members could agree to provide a single cost package to prospective users that wish to use both member's information and data for their repair situation.

The control program software may also request additional information from the user and may independently update the user computing terminal with new or updated stem cell lines or procedures. For example, a user that has previously obtained results in the field of stem cell treatments for type 1 diabetes would receive periodic updates from both members and independent sources in the stem cell/type 1 diabetes field. Providing relevant and targeted information and data to a user in a timely fashion is of enhanced value given the fast rate at which stem cell therapeutics are moving.

Once a series of results has been provided to a user based on the users needs, the user can identify those members that they wish to contact or bid upon. For example, a user may access the registry to provide a list of the likely members that could provide the license for the best treatment options for further discussion.

A member may also restrict that use of a particular stem cell item be identified and by users with certain professional qualifications or profit status. For example, a mesenchymal stem cell to be used for cardiac muscle repair that must be delivered to the coronary arteries only by a board certified cardiologist. Alternatively, a member may restrict an item for use only by not-for-profit users, etc.

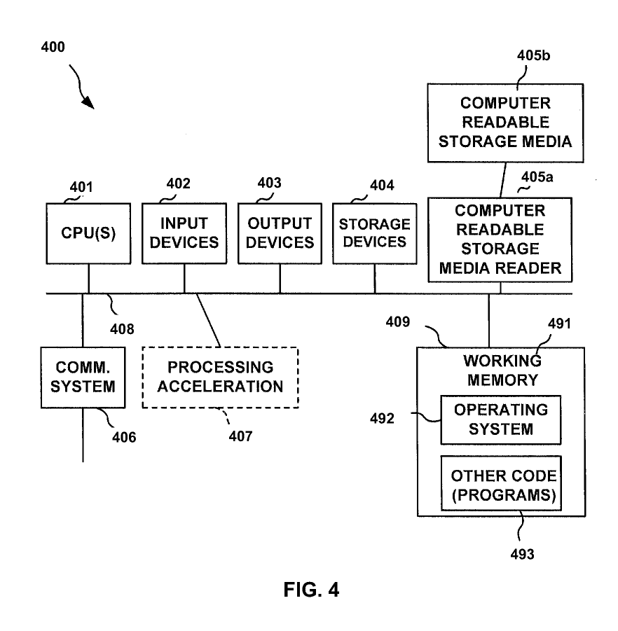

FIG. 4 illustrates a computerized system in accordance with the invention. Computerized system 400 is shown comprised of hardware elements that are electrically coupled via bus 408, including a processor 401, input device 402, output device 403, storage device 404, computer-readable storage media reader 405a, communication system 406 processing acceleration 407 and memory 409. Computer-readable storage representing remote, local, fixed and/or removable storage devices plus storage media, memory, etc for temporality and/or more permanently containing computer-readable information, i.e., the registry, which can include storage device 404 memory 409 and/or any other such accessible system 400 resource. Computerized system 400 also comprises software elements including an operating system and other code, such as programs, data and the like. As used herein, the term processor includes any of one or more circuits, processors, controllers, filed-programmable gate arrays, microprocessors, application-specific integrated circuits, other types of computational devices, or combinations thereof that are capable of performing functions ascribed to or associated with the processor.

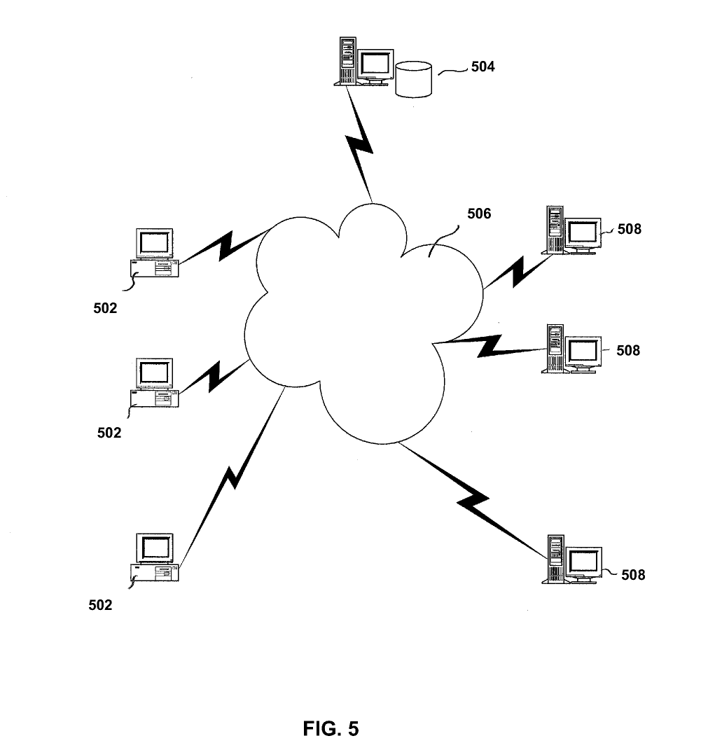

FIG. 5 provides an illustration of a computerized system implemented on a network interface. Computer or processing terminals 502 are used to input and store stem cell items onto the stem cell registry 504 via a networking interface 506. Marketplace users access the registry via the same or other computer or processing terminals 508. The number of members and users that utilize the computerized systems and methods of the invention is unlimited.

Network interface terminals may be general purpose computers but may include wireless devices, including wireless Personal Digital Assistants (PDAs), wireless web-enabled phones, pagers, etc. The Network may include the internet, one or more Local Area Networks (LANs), one or more Metropolitan Area Networks (MANs), one or more Wide Area Networks (WANs), one or more intranets, etc. The interface itself is known in the art but may be provided by an unshielded twisted pair wiring, wireless interface or coaxial cable.

Note that the stem cell marketplace may also be implemented in any number of operating environments, including personal computers, server computers, laptop computers, multiprocessor systems, cell phone, personal digital assistants, programmable electronics, minicomputers, mainframe computers and the like.

Note also that the stem cell marketplace may be described in the context of computer-executable instructions, such as program modules which can include routines, programs, objects, and components, data structures, which perform tasks or implement data types.

In one embodiment, a computerized method is provided for a stem cell marketplace. The method comprises a member or members of a stem cell marketplace inputting and storing information and/or data to a registry. Information and/or data, i.e., items, include submission of information to enable various parameters that users will use to identify optimal materials or procedures for their use. Members will also input and store other details necessary to the user once a sale or agreement has been obtained between the member and any particular user. The method further comprises a user accessing the stem cell marketplace to identify optimal stem cell repair procedures or materials for a personalized use. These uses are typically optimized for the user and based on parameters provided by members. Parameters can include: tissue source of cells, procedure parameters, cost parameters, re-implant registry parameters and laboratory parameters.

Methods can also include bidding and negotiations between a user and a member(s) and/or package deals where members or users participate together to obtain more favorable conditions for that group. For example, members may group together to provide a stem cell repair that includes materials and/or procedures necessary to accomplish the repair from each member. In one case, one member may provide a procedure for harvest of stem cells and another member may provide the IP and procedure for delivery of those cells into the patient at issue. In combination, the two members work together to simplify and make a procedure or use more uniform and consistent. Users' may group together to obtain more favorable costs or other like concerns as well.

Although not described in detail it is also envisioned that the embodiments of the present invention can be used by members to identify users for their stem cell items based on previous user entries in the marketplace. For example, a member can use the software to identify all users that utilized a particular procedure, if that member is now offering the same procedure.

Having generally described the invention, the same will be more readily understood by reference to the following examples, which are provided by way of illustration and are not intended as limiting.

### EXAMPLES

### Example 1

### Identification of Procedure for Autologous Stem Cell Implantation

A cardiologist who owns his own stem cell procurement, expansion and differentiation laboratory has a patient suffering from chronic heart failure (CHF). The patient has been identified for possible stem cell therapy given that the patient's heart has an ischemic injury involving a large amount of heart muscle. The cardiologist has two main objectives: 1) to use the best possible procedures for stem cell therapeutics on the heart while producing minimal complications; and 2) not to infringe any valid U.S. patent rights in the process, and thereby jeopardize his revenue stream.

The cardiologist enters the data base in accordance with an embodiment of the present invention. In this case the cardiologist is a member of the stem cell marketplace service and does not need to pay a fee for his procedure and information search. The cardiologist enters various parameters for the search in light of the two main criteria for the current patient anticipating a protocol that will describe the best site of stem cell harvest, i.e., tissue origin and harvest parameters; stem cell isolation procedures for that target harvest site; requirement for stem cell culture, i.e., do the harvested stem cells require culture and expansion prior to implantation into the patient; in vitro culture conditions to result in level of differentiation necessary for implantation; time required for stem cell expansion, i.e., how many cells need to be implanted for the therapeutic use; other materials necessary for implantation back into the patient, i.e., matrix, growth factors, platelet lysate, helper cells, etc; implant procedures for the target site in the patient; and follow-up, including parameters to track success of the procedure and decision points for when the procedure needs to be repeated.

Given the cardiologist input for his patient, several candidate stem cell lines and use procedures are provided. In this instance, the cardiologist is also provided non-autologous stem cell lines for comparison. In addition, the service provides whether or not the procedures or stem cell lines are proprietary and whether the owner of the information offers licensing terms, including cost considerations.

Based on the information the cardiologist identifies a procedure for obtaining mesenchymal stem cells from the patient's bone marrow, culture conditions and adjuvant factors necessary for best results in the myocardium and administration routes for the area of the patient's heart in need of repair. Licensing terms are provided to the cardiologist and a sale is made for approximately $1,500.

### Example 2

### Identification of Procedure for Autologous Stem Cell Implantation

An orthopedic surgeon owns a stem cell procurement, expansion and differentiation laboratory in conjunction with a local hospital. The relationship between the surgeon and hospital is a joint venture. The hospital and surgeon have identified stem cell therapeutics as a high priority for use in meniscus repairs. In general the target patient for this joint venture is not price sensitive, often requesting the best results without complications that technology and money can provide. In this particular case the patient is a professional athlete in need of off-season meniscus repair on his right knee.

As in Example 1, the orthopedic surgeon enters the stem cell marketplace data base in accordance with the present invention. Also as in Example 1, a data base search is performed on parameters meant to optimize the patient's goals. The surgeon is provided several different stem cell lines and procedures for procuring those lines (as well as comparative non-autologous stem cell lines). In this case the surgeon consults with the patient and identifies a procedure having a lower outcome probability on the knee, but has shown little or no complications. In this instance the technology is proprietary and covered by an issued U.S. patent, the licensing fee is $2,100.

### Example 3

### Identification of Procedure for Autologous Stem Cell Implantation

A cosmetic surgeon requires a stem cell line that she can use as “a filler.” She would like a stem cell line that can be used on numerous patients at a low cost, her clientele are often price sensitive and competition is strong for her type of practice. The cosmetic surgeon enters her parameters (as in Example 1) with a focus on her intended use and locates a couple of stem cell lines that provide low complication rate, but have been found to serve as filler sources of cells in the intended application.

In this case the cosmetic surgeon pays a one-time fee to use the stem cell marketplace data base. The results of her query provided her with non-autologous alternatives that have lower immunologic rejection.

What is claimed is:

1. A computerized method for personalizing a stem cell treatment for a user in need thereof by accessing an online stem cell marketplace having a registry from which the user may identify isolation and procurement procedures for stem cells of use, the method comprising: a) from a stem cell registry, downloading to the users' computing device one or more cell lines and procures based on i) a tissue source of stem cells; ii) stem cell procurement parameters; iii) cost parameters; iv) re-implant parameters and v) laboratory parameters; b) at the users computing device, analyzing the stem cell registry results of a) and identify one or more cell lines and procedures for use with the user; and c) at the users computing device, receiving from a registry member based on b) for potential stem cell line or procurement procedure analysis.

2. The method of claim 1, further comprising the user addressing a bid, via a network interface, to a stem cell registry member identified in c) to obtain stem cells or stem cell procurement procedure for use in personalizing the users' stem cell treatment.

3. The method of claim 2, further comprising the stem cell registry member providing a license for the user to enter based on parameters determined in relation to membership with the stem cell marketplace.

4. The method of claim 1 wherein the tissue source of stem cells is a determination of tissue type or body location.

5. The method of claim 1 wherein the stem cell procurement parameters includes: location, tissue type, delivery method, and disease type.

6. The method of claim 1 wherein the cost parameters includes cost amount and number of licenses required, and wherein the amount and number of licenses required further includes a maximum cost that user is willing to pay and a bid from the member to the user.

7. The method of claim 1 wherein the re-implant parameters includes risk complications, likelihood of positive outcome and cell-line certification and wherein the cell-line certification further requires a determination of whether restrictions on the number of patients to be treated exists with the registry information.

8. The method of claim 1 wherein the laboratory parameters includes in vitro cell culturing conditions and a request for what type of complexity the queried procedures requires.

9. A computerized system for optimizing a users' ability to identify a stem cell members' information and/or services, the members' information and/or service being most useful to the users' needs, comprising:
a registry storing at least two members' stem cell items;
a hardware element in communication with the registry, the hardware element executing software that identifies the member item in the registry that optimizes the users' need; and
the hardware element having a network interface accessible by the user to access the hardware element and identify the members' item.

10. The computerized system of claim 9 wherein the network interface is an internet interface.

11. The computerized system of claim 9 wherein the software creates a user need identifier, the user need identifier identifying the member having stored items on the registry most useful for the user.

12. The computerized system of claim 11 wherein the user need identifier further comprises a stem cell procurement item.

13. The computerized system of claim 12 wherein stem cell procurement item is based on location, tissue type, delivery method, or disease type.

14. The computerized system of claim 11 wherein the user need identifier further comprises a cost parameter.

15. The computerized system of claim 14 wherein the cost parameter includes cost, amount and number, of licenses required for the user to utilize a members' item.
